(19) United States
(12) Patent Application Publication
(10) Pub. No.: US 2025/0055898 A1
(43) Pub. Date: Feb. 13, 2025

(54) DELAY MEASUREMENTS BASED ON RTCP OR RTP HEADER EXTENSION FOR MULTIMEDIA APPLICATIONS

(71) Applicant: QUALCOMM Incorporated, San Diego, CA (US)

(72) Inventors: Liangping Ma, San Diego, CA (US); Imed Bouazizi, Celina, TX (US); Thomas Stockhammer, Bergen (DE)

(21) Appl. No.: 18/782,823

(22) Filed: Jul. 24, 2024

Related U.S. Application Data
(60) Provisional application No. 63/518,927, filed on Aug. 11, 2023.

(51) Int. Cl. H04L 65/65; H04J 3/06

(52) U.S. Cl. CPC H04L 65/65; H04J 3/0661

(57) ABSTRACT

Example devices and techniques are described for use with delay measurements. An example method includes determining whether a source port of a Real-Time Transport Protocol (RTP) packet of a multimedia application session is a same source port as a source port of a Real-Time Transport Control Protocol (RTCP) packet of the multimedia application session. The method includes determining whether a destination port of the RTP packet is a same destination port as a destination port of the RTCP packet. The method includes determining, based on whether the source port of the RTP packet is the same source port as the source port of the RTCP packet and whether the destination port of the RTP packet is the same destination port as the destination port of the RTCP packet, whether to use RTP header extensions for delay determination or to use RTCP packets for delay determination.

This application claims the benefit of U.S. Provisional Patent Application 63/518,927, filed Aug. 11, 2023, the entire content of which is incorporated by reference.

### TECHNICAL FIELD

This disclosure relates to transport of data, such as Real-Time Transport Protocol (RTP) and/or Secure Real-Time Transport Protocol (SRTP) packets.

### BACKGROUND

Applications, such as extended reality (XR) applications, may be accessed by a device over one or more networks from another device. The one or more networks may include wireless wide area network(s), such as a 5G network, wireless local area network(s), such as a Wi-Fi network, the Internet, and/or the like. As such, the end-to-end connection between the two devices may traverse different types of networks. Traversal of networks by a data packet may cause data packet delay.

### SUMMARY

In general, this disclosure describes techniques for improving accuracy of delay measurements. Delay measurements may be important in monitoring and/or improving a Quality of Service (QoS) and/or a Quality of Experience (QoE) of an application, such as an XR application. More particularly, this disclosure describes techniques for more accurately determining delay in end-to-end transportation of data packets, such as RTP/SRTP packets. RTP/SRTP packets may include RTP packets and/or SRTP packets. Either RTP header extensions or Real-Time Transport Control Protocol (RTCP) messages may be used to determine the delay. This disclosure describes techniques for determining whether to use RTP header extensions or to use RTCP messages for determining delay.

In one example, a method includes: determining, by a first computing device, whether a source port of a Real-Time Transport Protocol (RTP) packet of a multimedia application session is a same source port as a source port of a Real-Time Transport Control Protocol (RTCP) packet of the multimedia application session; determining, by the first computing device, whether a destination port of the RTP packet is a same destination port as a destination port of the RTCP packet; and determining, by the first computing device and based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

In another example, a computing device includes one or more memories configured to store a first data packet; and one or more processors in communication with the one or more memories, the one or more processors being configured to: determine whether a source port of a Real-Time Transport Protocol (RTP) packet of a multimedia application session is a same source port as a source port of a Real-Time Transport Control Protocol (RTCP) packet of the multimedia application session; determine whether a destination port of the RTP packet is a same destination port as a destination port of the RTCP packet; and determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

In yet another example, computer readable media media storing instructions, which, when executed, cause one or more processors to: determine whether a source port of a Real-Time Transport Protocol (RTP) packet of a multimedia application session is a same source port as a source port of a Real-Time Transport Control Protocol (RTCP) packet of the multimedia application session; determine whether a destination port of the RTP packet is a same destination port as a destination port of the RTCP packet; and determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating an example system that implements techniques for streaming media data over a network.

FIG. 1B is a block diagram illustrating another example system that implements techniques for streaming media data over a network.

FIG. 2 is a block diagram illustrating an end-to-end XR system in which data packets traverse more than one network.

FIG. 3 is a conceptual diagram illustrating example delays in an end-to-end connection for an XR application according to one or more aspects of this disclosure.

FIG. 4 is a conceptual diagram illustrating example delays.

FIG. 5 is a flow diagram illustrating an example technique for determining whether to use RTCP or RTP header extensions for delay measurements according to one or more aspects of this disclosure.

FIG. 6 is a conceptual diagram illustrating example techniques using a combination of one RTCP sender report and one RTCP receiver report to determine a delay according to one or more aspects of this disclosure.

FIG. 7 is a conceptual diagram illustrating example techniques using a combination of a first sender report and a second sender report to determine a delay according to one or more aspects of this disclosure.

FIG. 8 is a conceptual diagram illustrating an example RTCP timestamp message according to one or more aspects of this disclosure.

FIG. 9 is a conceptual diagram of an RTCP Sender Report in accordance with RFC3550.

FIG. 10 is a conceptual diagram of an RTCP Receiver Report in accordance with RFC3550.

FIG. 11 is a conceptual diagram of an RTCP Extended Report in accordance with RFC3611.

FIG. 12 is a conceptual diagram illustrating an RTCP Extended Report in accordance with RFC3611.

FIG. 13 is a conceptual diagram of an RTCP Extended Report in accordance with RFC3611.

FIGS. 14A and 14B are conceptual diagrams illustrating an example of the use of timestamps in an RTP header extension according to one or more aspects of this disclosure.

FIG. 15 is a conceptual diagram illustrating an example of the use of timestamps in a payload of an RTP packet according to one or more aspects of this disclosure.

FIG. 16 is a flow diagram illustrating example delay measurement techniques according to one or more aspects of this disclosure.

### DETAILED DESCRIPTION

In general, this disclosure describes techniques for using RTP header extensions or RTCP messages to determine delay measurements. More particularly, this disclosure describes techniques including determining whether to use RTP header extensions or to use RTCP messages to determine delay measurements. This disclosure also describes example packets. RTP packets may be used during a multimedia application session to exchange video data, audio data, user input, or other components of the multimedia application session. RTCP packets may be used to provide statistical and control information related to an RTP session, such as the multimedia application session.

In extended reality (XR) applications, an end-to-end connection may include both wireless wide area networks, such as 5G networks, and non-wireless wide area networks (e.g., non-5G networks). The non-5G networks may include the Internet, wireless local area networks (e.g., Wi-Fi networks), etc. Different networks may have different delays, some of which may be outside of the control of a service provider, such as a 5G service provider. Different flows through the different networks may incur different delays as well. For example, when a delay between a video flow and an audio flow are different, the video flow and audio flow may become out of sync, which may negatively affect the experience of a user of an application. Knowing a delay associated with packets traversing each of the networks and/or the entirety of network paths through the networks may permit a network provider to adjust the handling of such packets to improve the QoS or QoE of an application. While the techniques of this disclosure may be applicable to wireless wide area networks other than 5G networks, for the ease of description, a 5G network is used hereinafter as a representative example of a wireless wide area network.

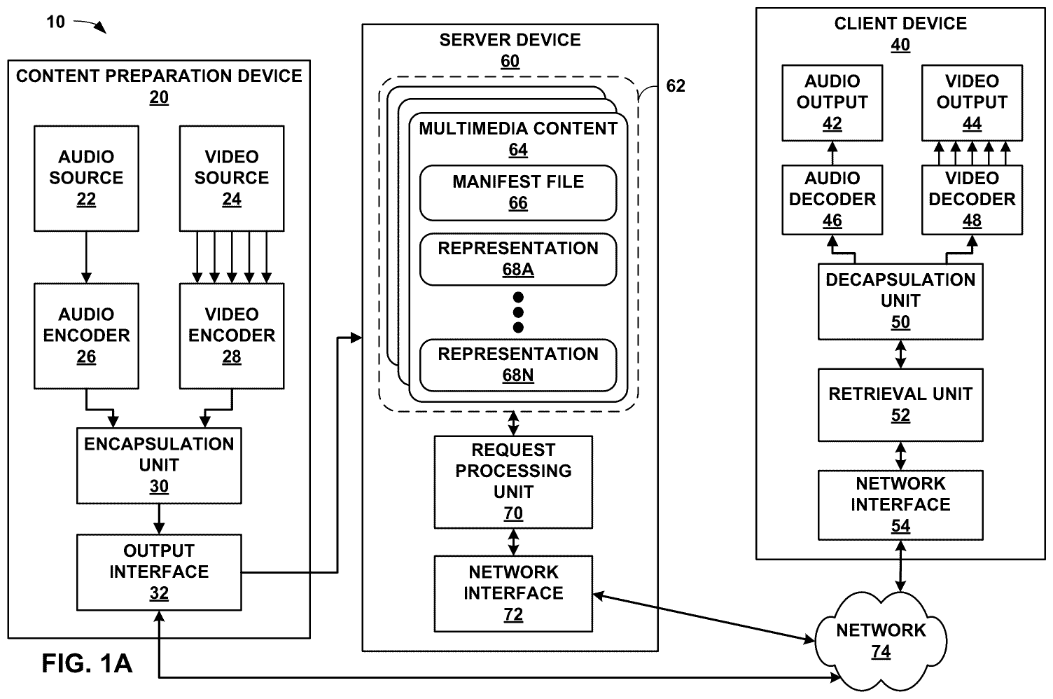

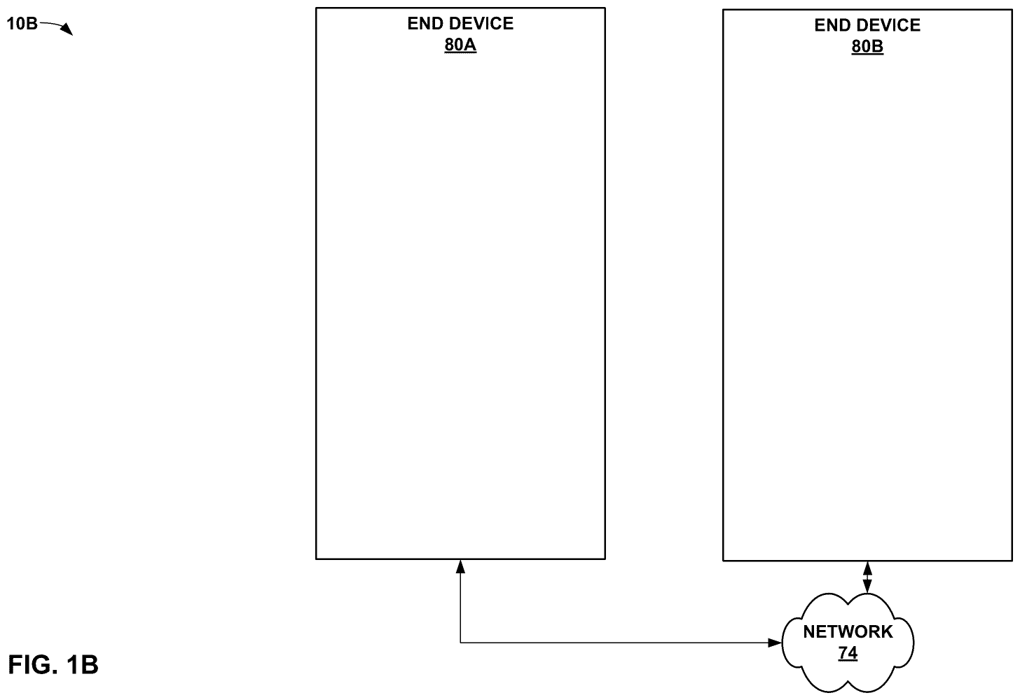

FIG. 1A is a block diagram illustrating an example system 10 that implements techniques for streaming media data over a network. In this example, system 10 includes content preparation device 20, server device 60, and client device 40. Server device 60 may be an XR application server. Client device 40 and server device 60 are communicatively coupled by network 74, which may comprise a wireless wide area network, a wireless local area network, the Internet, and/or the like. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1A, comprises audio source 22 and video source 24. Audio source 22 may comprise, for example, a microphone that produces electrical signals representative of captured audio data to be encoded by audio encoder 26. Alternatively, audio source 22 may comprise storage media storing previously recorded audio data, an audio data generator such as a computerized synthesizer, or any other source of audio data. Video source 24 may comprise a video camera that produces video data to be encoded by video encoder 28, storage media encoded with previously recorded video data, a video data generation unit such as a computer graphics source, or any other source of video data. Content preparation device 20 is not necessarily communicatively coupled to server device 60 in all examples, but may store multimedia content to separate media that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise computer-readable storage media comprising stored audio data, and video source 24 may comprise computer-readable storage media comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp. Note that these timestamps may be different than timestamps discussed herein with respect to use for determining a data packet delay.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data, but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive macroblocks, and whether a B-block can have sub-macroblock partitions less than 8×8 pixels. In this manner, a decoder may determine whether the decoder is capable of properly decoding the bitstream.

In the example of FIG. 1A, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of Scalable Video Coding (SVC) and view scalability information SEI messages in Multimedia Video Coding (MVC). These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to storage media, such as a universal serial bus (USB) interface, a compact disc (CD) or digital video disc (DVD) writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1A, server device 60 includes storage media 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage media 62. In some examples, request processing unit 70 may receive network requests from client device 40 in the form of RTP/SRTP packets and may deliver content, such as XR application content, to client device 40 in the form of RTP/SRTP packets.

Additionally, or alternatively, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally, or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1A, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bit rate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to computer-readable storage media such as, for example, an optical drive, a magnetic media drive (e.g., floppy drive), a universal serial bus (USB) port, a network interface, and/or other output interface. Output interface 32 outputs the video file to computer-readable media, such as, for example, a transmission signal, a magnetic medium, an optical medium, a memory, a flash drive, and/or other computer-readable media.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

The example of FIG. 1A describes the use of RTP, DASH, and HTTP-based streaming for purposes of example. However, it should be understood that other types of protocols may be used to transport media data. For example, request processing unit 70 and retrieval unit 52 may be configured to operate according to Real-time Streaming Protocol (RTSP), or the like, and use supporting protocols such as Session Description Protocol (SDP) or Session Initiation Protocol (SIP).

FIG. 1B is a block diagram illustrating another example system that implements techniques for streaming media data over a network. FIG. 1B is similar to the example of FIG. 1A, but FIG. 1B includes two end devices, rather than a client device and a server device. For example, each end device 80A and 80B of system 10B may be configured to both consume content from and provide content to the other of end device 80A and 80B. The system of FIG. 1B may implement the techniques disclosed herein.

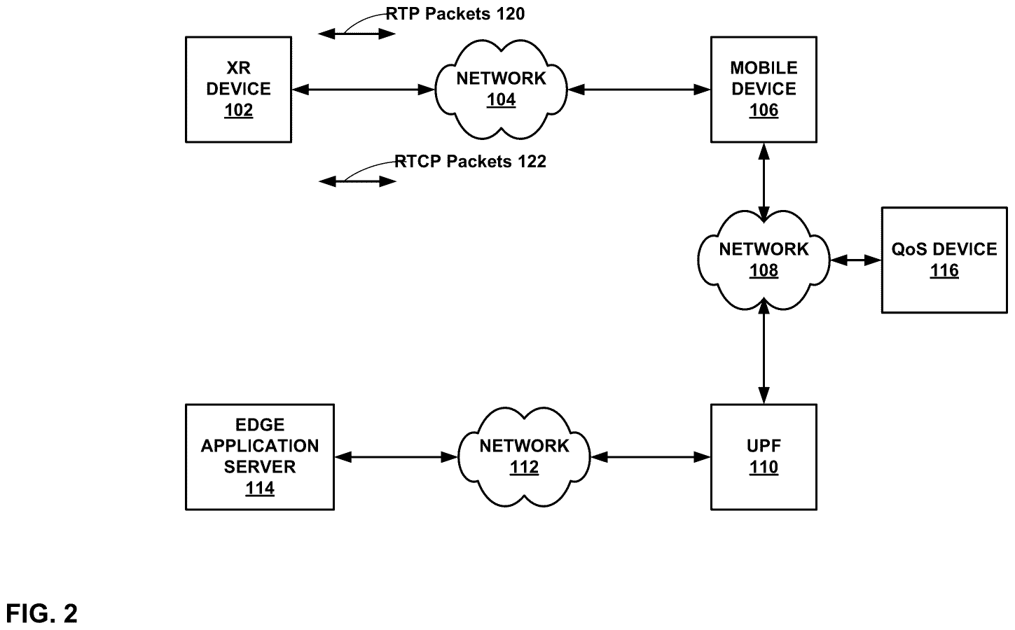

FIG. 2 is a block diagram illustrating an end-to-end XR system in which data packets traverse more than one network. XR device 102, which may be an example of client device 40 or a portion thereof, may be coupled to network 104. In some examples, XR device 102 may include XR glasses or an XR headset configured to deliver XR content to a user. In some examples, network 104 may include a wireless local area network, such as a Wi-Fi network. In some examples, network 104 may include multiple networks, such as a Wi-Fi network cascaded with an Ethernet.

Mobile device 106, which may be an example of client device 40 or a portion thereof, may be coupled to network 104 and network 108. Network 108 may include a wireless wide area network, such as a 5G network.

User plane function (UPF) 110 may be coupled to network 108 and network 112. Network 112 may include the Internet. In some examples, Network 112 may also include one or more local networks. Edge application server 114, which may be an example of server device 60, may be coupled to network 112 and to content preparation device 20 (not shown in FIG. 2). As such, an end-to-end connection between XR device 102 and edge application server 114 may traverse a plurality of networks, network 104, network 108, and network 112. These networks may be networks of different types, having different delay properties and different mechanisms for determining delay, for example, for quality of service (QoS) purposes. As such, techniques for determining an end-to-end delay may be desirable.

Network 108 may be coupled with QoS device 116. QoS device may be any computing device that may compute delays or compare delays to delay thresholds for QoS purposes.

During a multimedia application session, XR device 102 may send and/or receive RTP packets 120 to and/or from edge application servicer 114. The RTP packets 120 may include a 5-tuple indicating an IP source address, an IP destination address, a source port number, a destination port number, and a protocol number. RTP packets 120 may include video data, audio data, or other data of a multimedia application session. In some examples, RTP packets 120 may include multiple flows, such as a separate flow for video data and a separate flow for audio data. In such a case, the video data packets may include a different 5-tuple than the audio data packets. XR device 102 may also send and/or receive RTCP packets 122 to and/or from edge application server 114. The RTCP packets 122 may also include a 5-tuple indicating an IP source address, an IP destination address, a source port number, a destination port number, and a protocol number. Rather than include video data, audio data, or the like, the RTCP packets may include statistical and control information relating to the RTP session of RTP packets 120 (e.g., the multimedia application session).

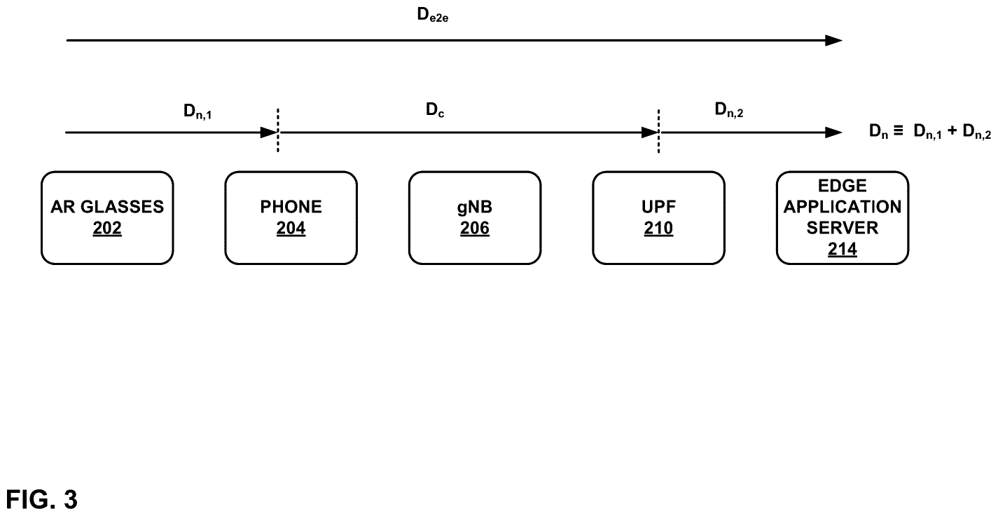

FIG. 3 is a conceptual diagram illustrating example delays in an end-to-end connection for an XR application according to one or more aspects of this disclosure. In the example of FIG. 3, the wireless wide area network (such as network 108) is referred to as a 5G network, represented as gNodeB (gNB) 206 in FIG. 3. As can be seen in FIG. 3, the end-to-end delay Dₑ₂ₑ may be equal to the delay in the 5G network D_{c} between phone 204 (which may be an example of mobile device 106) and UPF 210 (which may be an example of UPF 110), plus the delay from the AR glasses 202 (which is an example of XR device 102) to phone 204, D_{n,1}, and the delay from UPF 210 to edge application server 214, D_{n,2}. The non-5G network delays Dₙ, the remaining delay other than delay in the 5G network D_{c}, may therefore be a sum of the delays D_{n,1} and D_{n,2}, such that Dₙ=D_{n,1}+D_{n,2}.

The non-5G network delays may be estimated via end-to-end delay measurements. There are existing schemes or techniques to measure 5G network delay D_{c}, e.g., per TS23.501 clause 5.33.3. Measurement packets (on the 5G network and non-5G networks) should be representative of XR data packets: e.g., have a same QoS treatment, similar packet size, etc.

However, the QoS treatment received by measurement packets may be different from that received by the data packets themselves, e.g., when using out-of-band measurement techniques. For example, in the 5G network, a measurement message and a data packet may use different protocols (e.g., ICMP messages (Echo or Echo Reply). For example, the measurement message may have protocol number 1, while data packets (RTP/UDP) may have protocol number 17. A measurement message and a data packet may have different IP 5-tuples (IP source address, IP destination address, source port number, destination port number, protocol number) and therefore travel different paths. A measurement message and a data packet may be mapped to different QoS flows, and may receive different QoS treatment in the 5G network. On the Internet, the measurement packet and the data packet may differ in the DSCP value in the IP packet header. In a Wi-Fi network (e.g., network 104), the measurement packet and the data packet may be mapped to different access categories. Additionally, the packet size difference between the measurement packet and the data packet may affect the accuracy of the delay measurement, especially for low bit rate links.

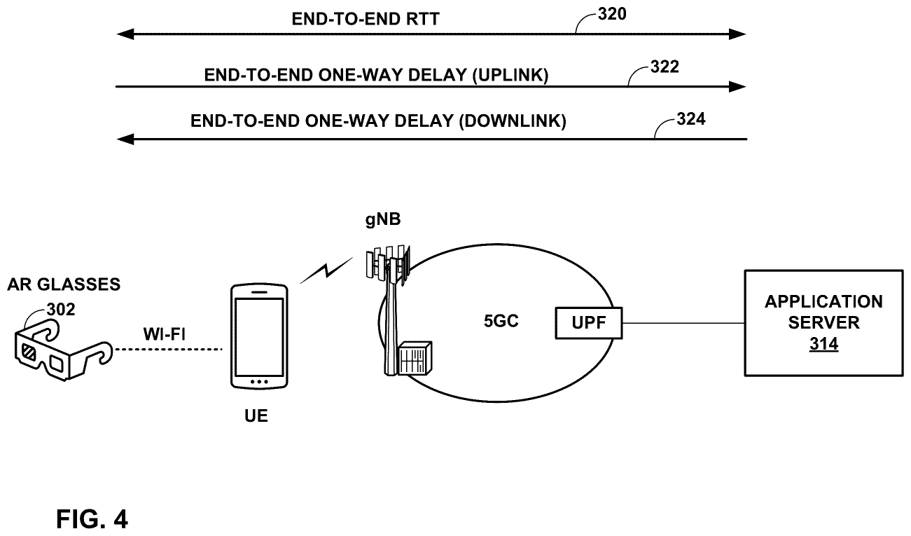

FIG. 4 is a conceptual diagram illustrating example delays. Measuring delay may include measuring an end-to-end round trip time (RTT) 320, an end-to-end one-way delay for an uplink 322, and/or an end-to-end one-way delay for a downlink 324. In some examples, end-to-end RTT 320 may include a time from when AR glasses 302 (with may be an example of XR device 102) sends a particular packet to application server 314 until application server 314 receives the particular packet and the time from when application server 314 sends a response packet from application server 314 in response to the particular packet until the AR glasses 302 receives the response packet. In other words, end-to-end RTT may include the travel time of a particular packet from AR glasses 302 to application server 314 and the travel time of a response packet from application server 314 to AR glasses 302, but not the time application server 314 spends processing the particular packet and creating the response packet.

End-to-end one-way delay for an uplink 322 may include delay between when AR glasses 302 sends a packet to application server 314 until application server 314 receives the packet. End-to-end one-way delay for a downlink 324 may include a delay between when application server 314 sends a packet to AR glasses 302 and when AR glasses 302 receives the packet.

RTP header extensions were proposed in 3GPP SA4 SmarTAR (TR 26.806, June 2023) for use in determining accurate end-to-end delays for multimedia applications. RTCP packets (e.g., sender report and receiver report packets) may also be used to measure RTT and one-way delays in a network.

According to Internet Engineering Task Force (IETF) RFC 3550, RTCP packets use port numbers that are different from those used for media-carrying RTP packets. Therefore, if one were to use RTCP packets to measure end-to-end delays under IETF RFC 3550, the measurements may not represent the delay experienced by the media-carrying RTP packets because the paths taken by the RTCP packets and the media-carrying RTP packets are different. As such, using RTCP packets to measure end-to-end delays in such situations may lead to erroneous delay measurements, which may contribute to, or cause, errors which may affect the QoS and/or QoE of an application.

According to IETF RFC 5761, and in recent implementations, RTCP packets and RTP packets can be multiplexed into the same port numbers, hence attaining the same Internet Protocol (IP) 5-tuple. In such cases, the use of RTCP packets may be a candidate for use in accurate end-to-end delay measurements.

This disclosure describes techniques that consider both the use of RTCP packets in end-to-end delay measurements and the use of RTP header extensions in end-to-end delay measurements. As either RTCP packets or RTP header extensions may be used to determine any such delay, a device may be faced with a choice on whether to use RTCP packets or RTP header extensions to determine end-to-end delay.

In one example, according to the techniques of this disclosure, a device (e.g., any computing device of this disclosure), may determine if RTCP packets and RTP packets are multiplexed into the same ports in a multimedia application session. Such multiplexing may include a) all media being multiplexed into the same pair of ports, or b) flows of the media being multiplexed into multiple pairs of ports, e.g., audio into the first pair of ports, video into the second pair of ports, etc. For example, the source port and destination port of the audio flow of an RTCP packet match the source port and the destination port of an RTP packet, the source port and destination port of the video flow of an RTCP packet match the source port and the destination port of an RTP packet, etc. In such an example, all RTP packets of the multimedia application session do not need to have the identical source port or destination port.

For example, AR glasses 302 may determine whether a source port of an RTP packet a multimedia application session (e.g., of RTP packets 120 of FIG. 2) is a same source port as a source port of an RTCP packet of the multimedia application session (e.g., of RTCP packets 122 of FIG. 2). AR glasses 302 may determine whether a destination port of the RTP packet of the multimedia application session is a same destination port as a destination port of the RTCP packet of the multimedia application session. AR glasses 302 may determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

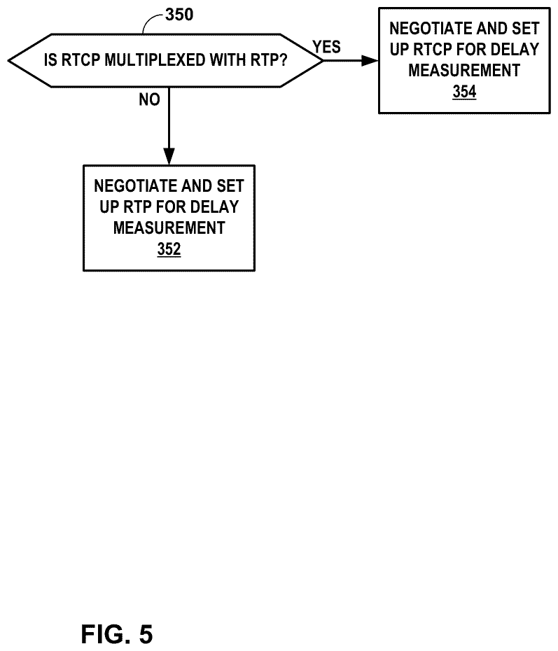

FIG. 5 is a flow diagram illustrating an example technique for determining whether to use RTCP or RTP header extensions for delay measurements according to one or more aspects of this disclosure. In the example of FIG. 5, a device, such as mobile device 106 (which may be a UE), may determine whether RTCP packets and RTP packets are multiplexed into the same ports in a multimedia application session (350). In other words, both RTCP packets and RTP packets of a multimedia application session are multiplexed into the same ports.

If the device determines that RTCP packets and RTP packets are not multiplexed into the same ports in a multimedia application session (e.g., the “NO” path from box 350), the device may negotiate and set up the use of RTP header extension(s) for delay measurements (352) with another device (e.g., application server 114). In some examples, if the device determines that RTCP and RTP are not multiplexed into the same ports in a multimedia application session and the allowed error in delay measurement is less than (or less than or equal to) a threshold, the device may negotiate and set up the use of RTP header extension(s) for delay measurements with another device (e.g., application server 114).

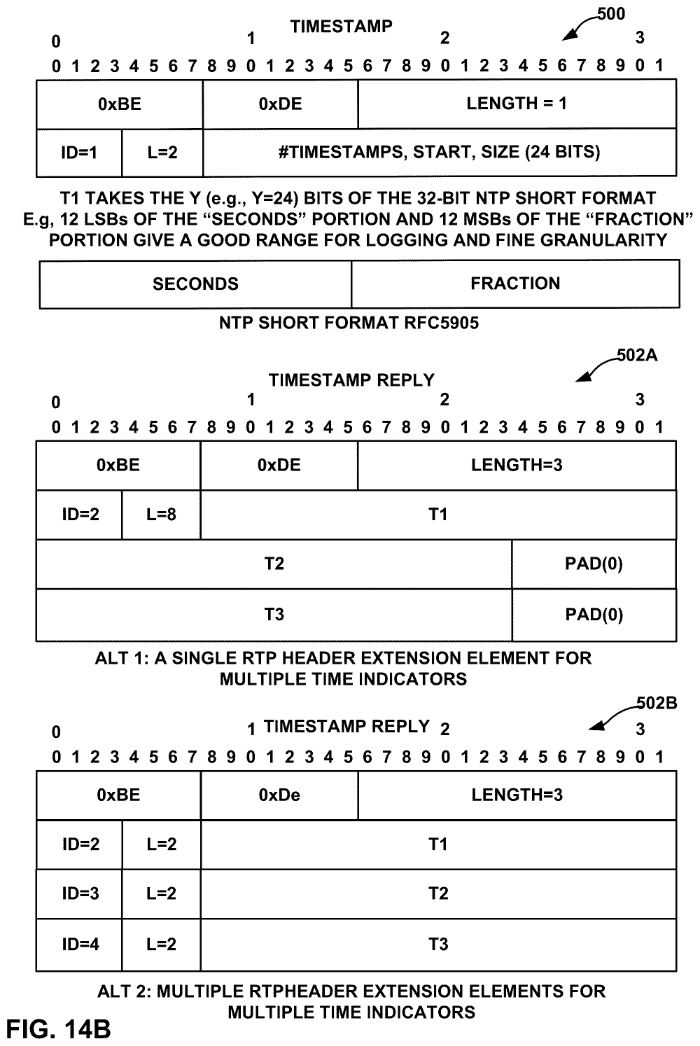

For example, mobile device 106 and application server 114 may set up the use of RTP header extensions for delay measurements between mobile device 106 (or XR device 102) by using an RTP header extension to indicate that a payload of the RTP packet includes timestamp(s), delay measurement information, or the like. For example, any RTP packet that includes timestamp(s) and/or other delay measurement information may include an RTP header extension indicating that the RTP packet payload includes the timestamp(s) and/or other delay measurement information. An example of such use is discussed further below with respect to FIGS. 14A and 14B.

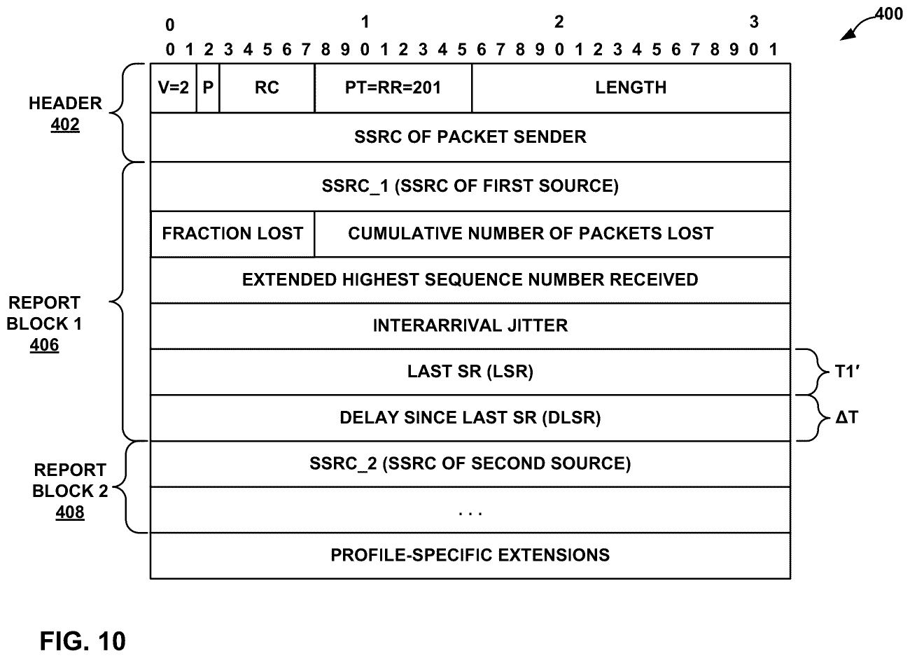

Alternatively, or additionally, for example, mobile device 106 and application server 114 may set up the use of RTP header extensions for delay measurements by including, in an RTP header extension itself, the timestamp(s), delay measurement information, or the like. For example, mobile device 106 (or XR device 102) may include any timestamp(s), delay measurement information, or the like in an RTP packet header extension itself, rather than in the RTP packet payload. An example of such use is discussed further below with respect to FIG. 10.

More information on utilizing an RTP header extension for delay measurements may be found in U.S. patent application Ser. No. 18/168,903, entitled “MEASURING DATA PACKET DELAY IN AN END-TO-END COMMUNICATION PATH,” filed on Feb. 14, 2023, and U.S. patent application Ser. No. 18/347,977, entitled “REAL-TIME TRANSPORT PROTOCOL HEADER EXTENSION FOR IN-BAND DELAY MEASUREMENT,” filed on Jul. 6, 2023, the entire content of both of which is hereby incorporated by reference.

If the device determines that RTCP packets and RTP packets are multiplexed into the same ports in a multimedia application session (e.g., the “YES” path from box 350), the device may negotiate and set up the use of RTCP for delay measurements (354) with another device (e.g., application server 114), such as a combination of different types of RTCP messages to be sent and the periodicity of the RTCP messages to be sent for delay measurement.

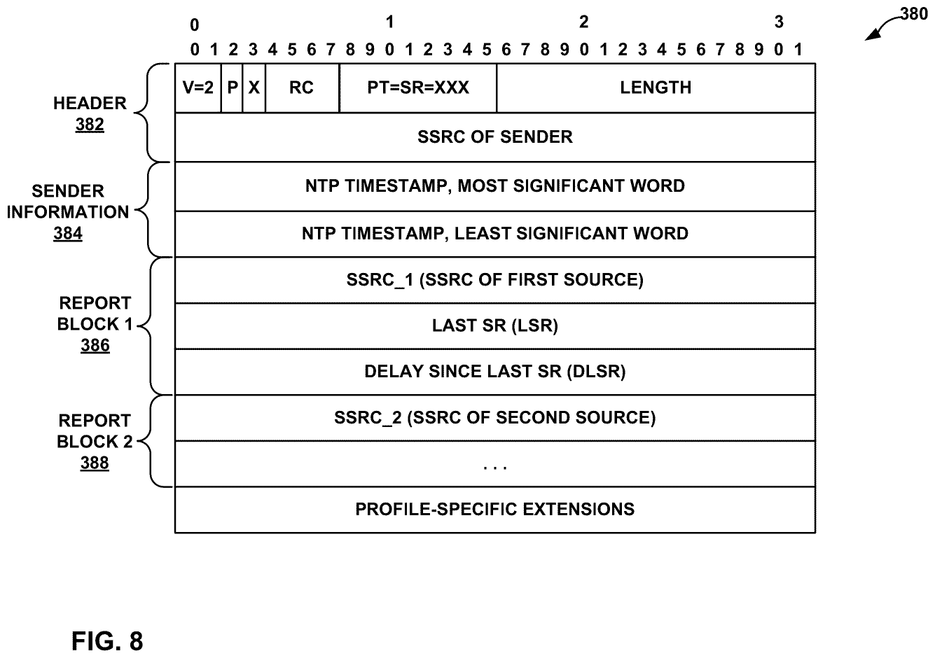

The devices may negotiate (e.g., via session description protocol (SDP)) which combination of RTCP messages (e.g., RTCP sender report, RTCP receiver report, RTCP extended reports, RTCP delay measurement message, an RTCP timestamp message, such as that of the example of FIG. 8, or the like) may be sent for delay measurements.

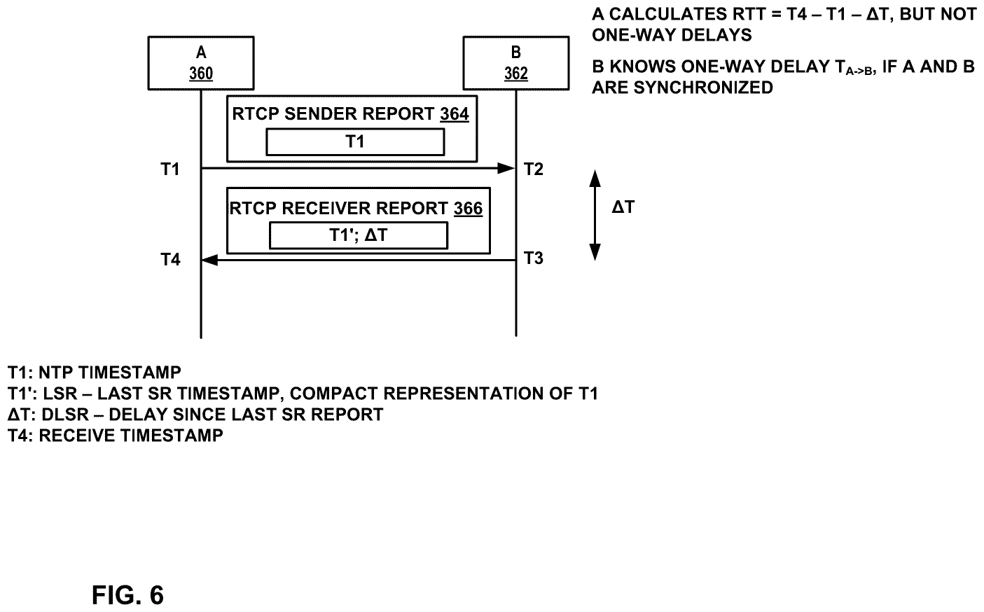

FIG. 6 is a conceptual diagram illustrating example techniques using a combination of one RTCP sender report and one RTCP receiver report to determine a delay according to one or more aspects of this disclosure. FIG. 6 depicts device A 360 and device B 362. Device A 360 and device B 362 may represent any of the computing devices discussed herein between which determination of an end-to-end delay is desired. For example, one of device A 360 may represent one of AR glasses 302 or application server 314 and device B 362 may represent the other of AR glasses 302 or application server 314.

For example, device A 360 may send an RTCP sender report 364 to device B 362 including a network time protocol (NTP) timestamp T1. Device B 362 may determine T1′ which may be a compact representation of T1 from RTCP sender report 364. For example, T1′ may include the middle 32 bits of the 64 bits of NTP timestamp T1. In other words, T1′ may not include the 16 most significant bits and the 16 least significant bits of T1. In other examples, T1′ may include only the 32 least significant bits of timestamp T1 or may include some bits of timestamp T1 that do not include the very most significant bits or the very least significant bits. For example, T1 may be 64 bits in length and the most significant bits may represent a year, the next most significant bits represent a month, etc. Because the most significant bits are unlikely to change during an end-to-end transit of a packet, in some examples, such bits may be omitted from T1′. Additionally, the least significant bits may represent nanoseconds. Because nanoseconds may be of a higher level of precision than is needed for the end-to-end delay measurements, in some examples the least significant bits may be omitted from T1. By limiting the number of bits used for T1′, the techniques of this disclosure may save bandwidth used to transmit RTCP receiver reports.

When device B 362 transmits corresponding RTCP receiver report 366, device B 362 may include in RTCP receiver report 366 the determined T1′ and a representation ΔT, which may be a delay between the receipt of RTCP sender report 364 by device B 362 and the sending of RTCP receiver report 366 by device B 362. In some examples, ΔT may be viewed as a processing delay of device B 362. Device A 360 may determine a receive timestamp T4 when device A 360 received RTCP receiver report 366 from device B 362. Device A 360 may then calculate an RTT by RTT=T4−T1−ΔT. Device B 362 should know the one-way delay from device A 360 to device B 362 if the two devices are synchronized.

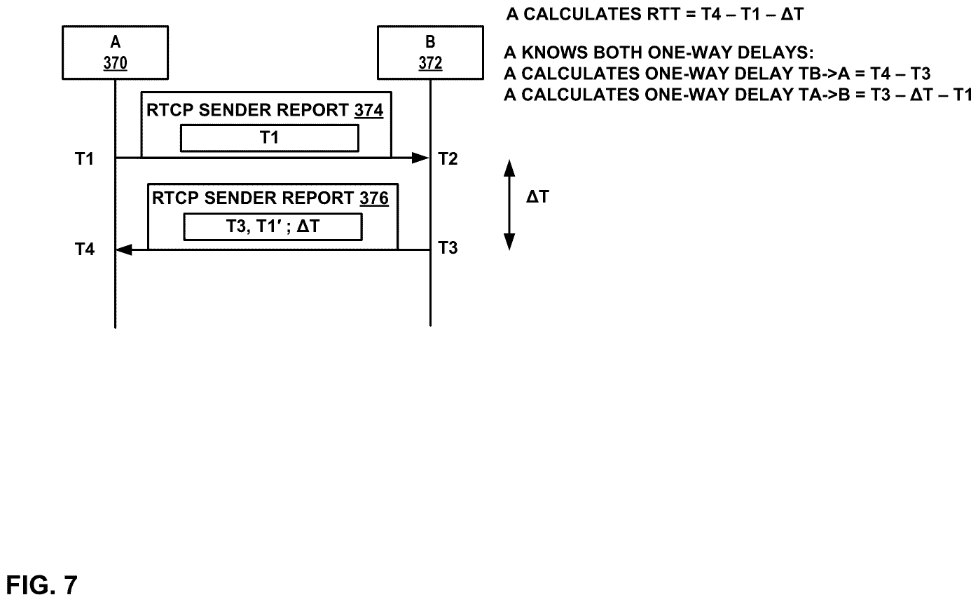

FIG. 7 is a conceptual diagram illustrating example techniques using a combination of a first RTCP sender report and a second RTCP sender report to determine a delay according to one or more aspects of this disclosure. FIG. 7 depicts device A 370 and device B 372. Device A 370 and device B 372 may represent any of the computing devices discussed herein between which determination of an end-to-end delay is desired. For example, one of device A 370 may represent one of AR glasses 302 or application server 314 and device B 372 may represent the other of AR glasses 302 or application server 314.

For example, device A 370 may send a first RTCP sender report 374 to device B 372 including timestamp T1. Device B 372 may determine T1′ which may include the last RTCP sender report timestamp, which may be a compact representation of T1 from the last RTCP sender report received by device B 372 (e.g., first RTCP sender report 374). For example, device B 372 may determine T1′ as described above with respect to FIG. 6. When device B 372 transmits a second RTCP sender report 376, device B 372 may include T1′, a representation ΔT, and a timestamp T3 associated with a time device B 372 transmits the second RTCP sender report 376. ΔT may be a representation of the delay between the receipt of the first RTCP sender report 374 by device B 372 and the sending of the second RTCP sender report 376 by device B 372. In some examples, ΔT may be viewed as a processing delay of device B 362. Device A 370 may determine a receive timestamp T4 when device A 370 receives the second RTCP sender report 376 from device B 372. Device A 370 may then calculate an RTT by RTT=T4−T1−ΔT. In some examples, device A 370 may calculate either or both one-way delays such as T_{B->A}=T4−T3 and/or T_{A->B}=T3−ΔT−T1.

The devices may also negotiate (e.g., via SDP) the periodicity of the RTCP messages, e.g., one RTCP sender report packet every 50 ms, one RTCP sender report packet every 100 RTP packets, or the like. In some examples, the periodicity may be required to meet an overhead constraint, such as RTCP traffic being below 5% of the total amount of traffic. In some examples, the periodicity may not be required to meet an overhead constraint.

The current existing RTCP sender report effectively conveys the following timestamps: originate timestamp (T1), receive timestamp (T2), transmit timestamp (T3), and final timestamp (T4). However, the current RTCP sender report also carries other information not relevant to delay measurements. As such, it may be desirable to define a RTCP message that carries (or conveys) less information. For example, it may be desirable to have an RTCP message that carries only the information described with respect to FIGS. 6-7, or an RTCP message that only includes the originate timestamp (T1), receive timestamp (T2), transmit timestamp (T3), and/or representation(s) thereof (e.g., ΔT) with a synchronization source (SSRC). Such an RTCP sender report would reduce communication overhead, especially when the RTCP packets are sent relatively frequently.

FIG. 8 is a conceptual diagram illustrating an example RTCP timestamp message according to one or more aspects of this disclosure. RTCP timestamp message 380 may include header 382, sender information 384, report block 1 386, and report block 2 388. In some examples, RTCP timestamp message 380 may be a type of RTCP packet different than an RTCP sender report and an RTCP receiver report.

In the example of FIG. 8, header 382 may include a version number V of two bits. This version number identifies a version of RTP, which may be the same in RTCP packets as in RTP packets. For example, the V may be 2. Header 382 may include a padding bit P. If the padding bit is set, it may indicate that the RTCP packet includes additional padding octets at the end of the packet that are not part of control information, but are reflected in the length field. Header 382 may include a reception report count (RC) which may be 5 bits which indicates a number of reception report blocks contained in the packet. Header 382 may include a packet type (PT) which may be 8 bits and may indicate that the packet is a sender report (SR) of a certain type (XXX). Header 382 may include a length field of 16 bits which may indicate the length of the RTCP packet in 32-bit words minus one (inclusive of the header and any padding). Header 382 may also include SSRC of 32 bits, which may indicate a synchronization source identifier of the originator of this SR packet.

Sender information 384 may include a 64-bit NTP timestamp (T3) which may include a most significant word and a least significant word. Report block 1 386 may include a source identifier of 32 bits identifying the SSRC of the source to which the information in this reception report block pertains. Report block 1 386 may include T1′, which may be a compact representation of T1 from a last sender report (LSR), shown as LSR. Report block 1 386 may include ΔT, a delay since last sender report (DLSR).

In some examples, RTCP timestamp message 380 may further include report block 2 388, which may include similar information to report block 1 386, such as an SSRC of a second source, etc. RTCP timestamp message 380 may also include profile-specific extensions.

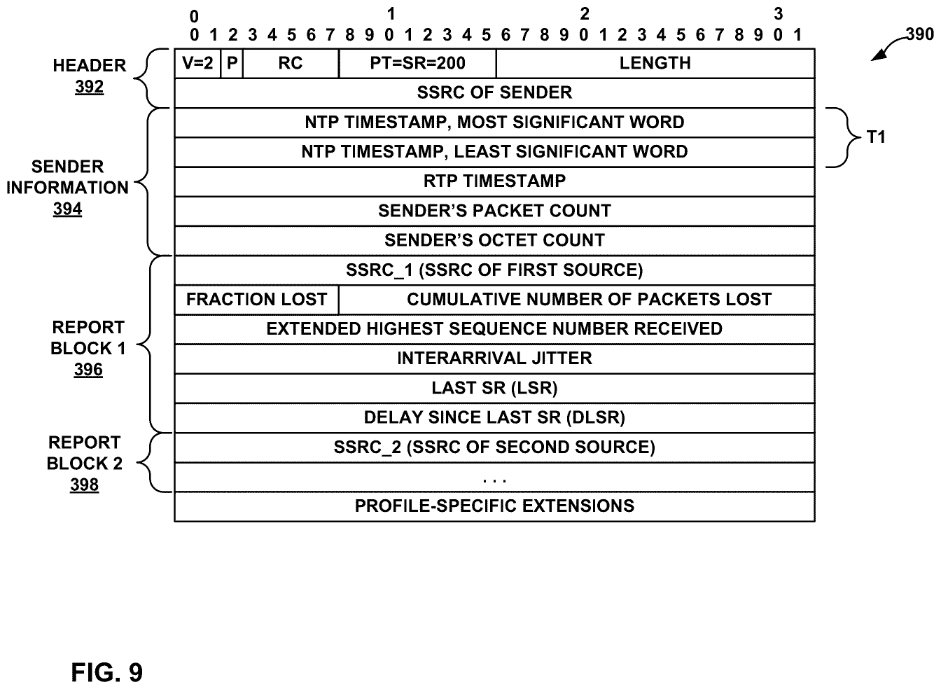

FIG. 9 is a conceptual diagram of an RTCP Sender Report in accordance with RFC3550. RTCP Sender Report 390 may include header 392, sender information 394, report block 1 396, and report block 2 398.

In the example of FIG. 9, header 392 may include a version number V of two bits. This version number identifies a version of RTP, which may be the same in RTCP packets as in RTP packets. For example, the V may be 2. Header 392 may include a padding bit P. If the padding bit is set, it may indicate that the RTCP packet includes additional padding octets at the end of the packet that are not part of control information, but are reflected in the length field. Header 392 may include a reception report count (RC) which may be 5 bits which indicates a number of reception report blocks contained in the packet. Header 392 may include a packet type (PT) which may be 8 bits and may indicate that the packet is a sender report (SR) of a certain type (200). Header 392 may include a length field of 16 bits which may indicate the length of the RTCP packet in 32-bit words minus one (inclusive of the header and any padding). Header 392 may also include SSRC of 32 bits, which may indicate a synchronization source identifier of the originator of this SR packet.

Sender information 394 may include a 64-bit NTP timestamp (T1) which may include a most significant word and a least significant word. Sender information 394 may also include an RTP timestamp, which may correspond to the NTP timestamp, but may include a same random offset as in RTP timestamps in data packets. Sender information 394 may include a sender's packet count which may indicate a total number of RTP data packets transmitted by the sender since starting transmission up until the time RTCP Sender Report 390 was generated. Sender information 394 may also include a sender's octet count which may indicate a total number of payload octets (not including headers or padding) transmitted by the sender since starting transmission up until the time RTCP Sender Report 390 was generated.

Report block 1 396 may include a source identifier of 32 bits in length identifying the SSRC of the source to which the information in this reception report block pertains. Report block 1 396 may include fraction lost which may be 8 bits in length. Fraction lost may indicate a fraction of RTP data packets from the SSRC identified since the last Sender Report or Receiver Report was sent. Report block 1 396 may include a cumulative number of packets lost which may be 24 bits in length and indicate a total number of RTP packets from the SSRC identified since the beginning of reception. Report block 1 396 may include an extended highest sequence number received of 32 bits in length. The least significant 16 bits may identify the highest sequence number received in an RTP data packet from the SSRC identified. The most significant 16 bits may extend the sequence with a corresponding count of sequence number cycles. Report block 1 396 may include interarrival jitter of 32 bits indicative of an estimate of statistical variance of the RTP data packet arrival time. Report block 396 1 may include a last Sender Report timestamp (LSR) which may be the middle 32 bits out of the 64 bits in the NTP timestamp received as part of the most recent RTCP Sender Report packet from the SSRC identified (e.g., T1′). Report block 1 396 may also include a 32-bit delay since last SR which may represent a delay between receiving a last SR packet from the identified SSRC and sending report block 396.

In some examples, RTCP Sender Report 390 may further include report block 2 398, which may include similar information to report block 1 396, such as an SSRC of a second source, etc. RTCP Sender Report 390 may also include profile-specific extensions.

It should be noted that RTCP Sender Report 390 includes fields not present in RTCP timestamp message 380 and conveys information not relevant to delay measurement. As such, the use of RTCP timestamp message 380 may be a more bandwidth efficient technique for determining delay than the use of RTCP Sender Report 390.

FIG. 10 is a conceptual diagram of an RTCP Receiver Report in accordance with RFC3550. RTCP Receiver Report 400 may include header 402, report block 1 406, and report block 2 408. The contents of each of header 402, report block 1 406, and report block 2 408 may be similar to that of RTCP Sender Report 390 of FIG. 9. For example, a computing device may send a sender report if a site has sent any data packets during the interval since issuing the last report or the previous report, otherwise the computing device may send a receiver report. As can be seen, RTCP Receiver Report 400 also includes additional information not included in RTCP timestamp message 380 of FIG. 8.

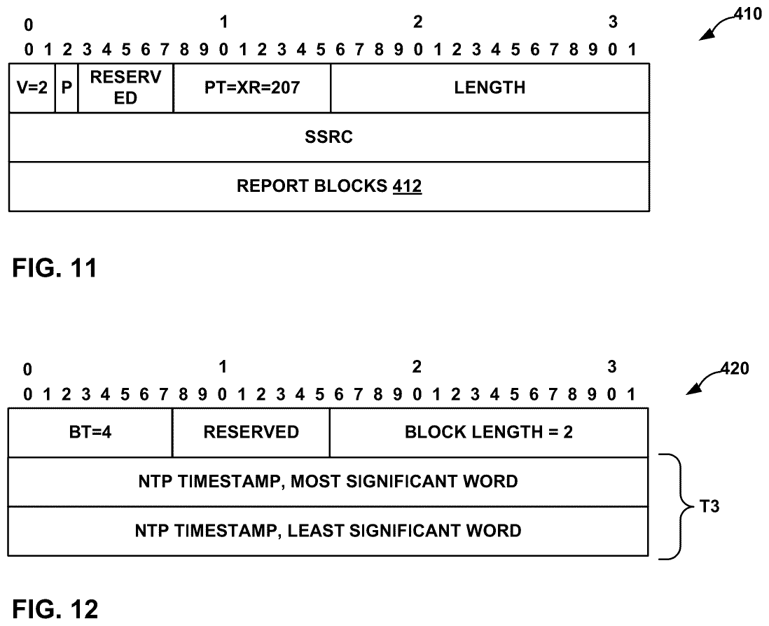

FIG. 11 is a conceptual diagram of an RTCP Extended Report in accordance with RFC3611. In some examples, RTCP extended report 410 may include, in report blocks 412, a receiver reference time report block and a delay since the last receiver report (DLRR). Such information may be used by a computing device to measure RTT among non-sending devices.

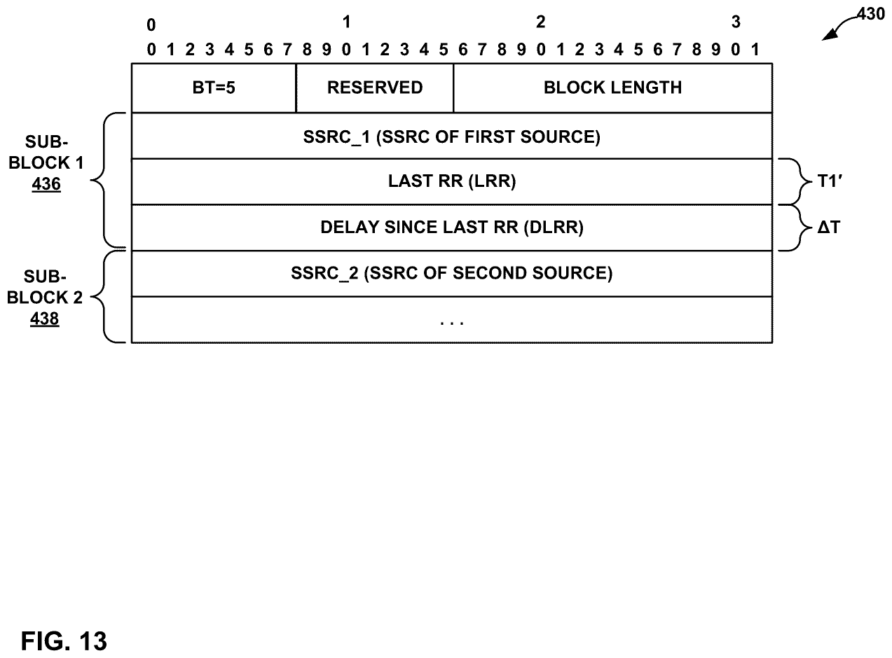

FIG. 12 is a conceptual diagram illustrating an RTCP Extended Report in accordance with RFC3611. In some examples, RTCP extended report 420 may include a receiver reference time report block. This report block allows a non-sender to report a time of transmit (e.g., T3).

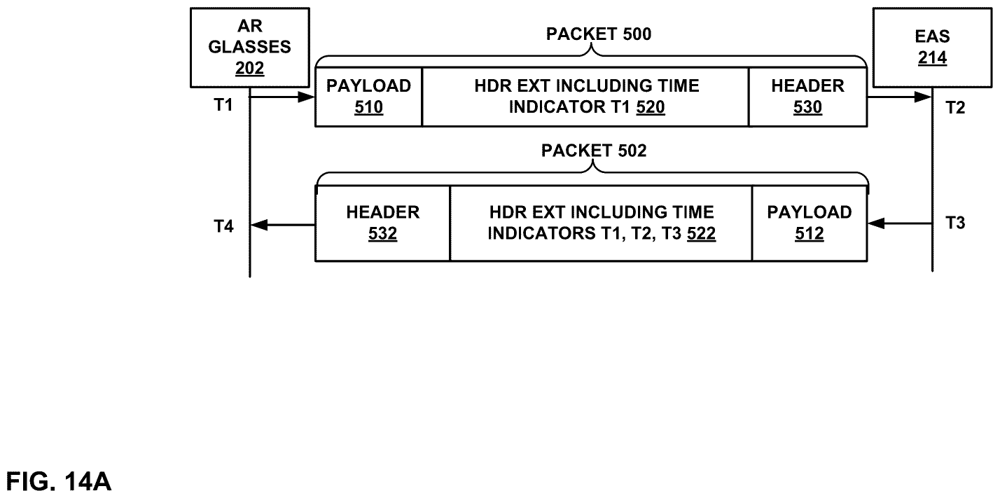

FIG. 13 is a conceptual diagram of an RTCP Extended Report in accordance with RFC3611. In some examples, RTCP extended report 430 may include sub-block 1 436 and sub-block 2 438. Sub-block 1 436 may include a representation of the last receiver report timestamp (shown as last receiver report (LRR)) (e.g., T1′), and an indication of delay since the last receiver report (DLRR) (e.g., ΔT). In some examples, this report block includes the NTP timestamp copied from RTCP sender report, e.g., T1.

FIGS. 14A and 14B are conceptual diagrams illustrating an example of the use of timestamps in an RTP header extension according to one or more aspects of this disclosure.

Packet 500 may be an RTP packet. Packet 500 may include: a payload 510, which, for example, may include video data; a header extension 520, which may include one or more header extension elements, carrying a first time indicator T1; and a header 530, which may be an RTP header. For example, AR glasses 202 may generate packet 500 to send to edge application server 214.

Packet 502 may also be an RTP packet. Packet 502 may include: a payload 512, which in this example may include video data; a header extension 522, which may include one or more header extension elements, carrying first time indicator T1, a second time indicator T2, and a third time indicator T3; and a header 532, which may be an RTP header. Edge application server 214 may determine second time indicator T2 upon receiving packet 500 and may determine third time indicator T3 after processing packet 500 and before transmitting packet 502. In some examples, a difference between second time indicator T2 and third time indicator T3 may represent a processing delay associated with edge application server 214 processing packet 500.

AR glasses 202 may determine a fourth time indicator T4 upon receiving packet 502. AR glasses 202 may use first time indicator T1, second time indicator T2, third time indicator T3, and/or time indicator T4 when determining a data packet delay.

FIG. 14B depicts an example format of packet 500 and two examples of alternative formats of packets 502 (shown as 502A and 502B).

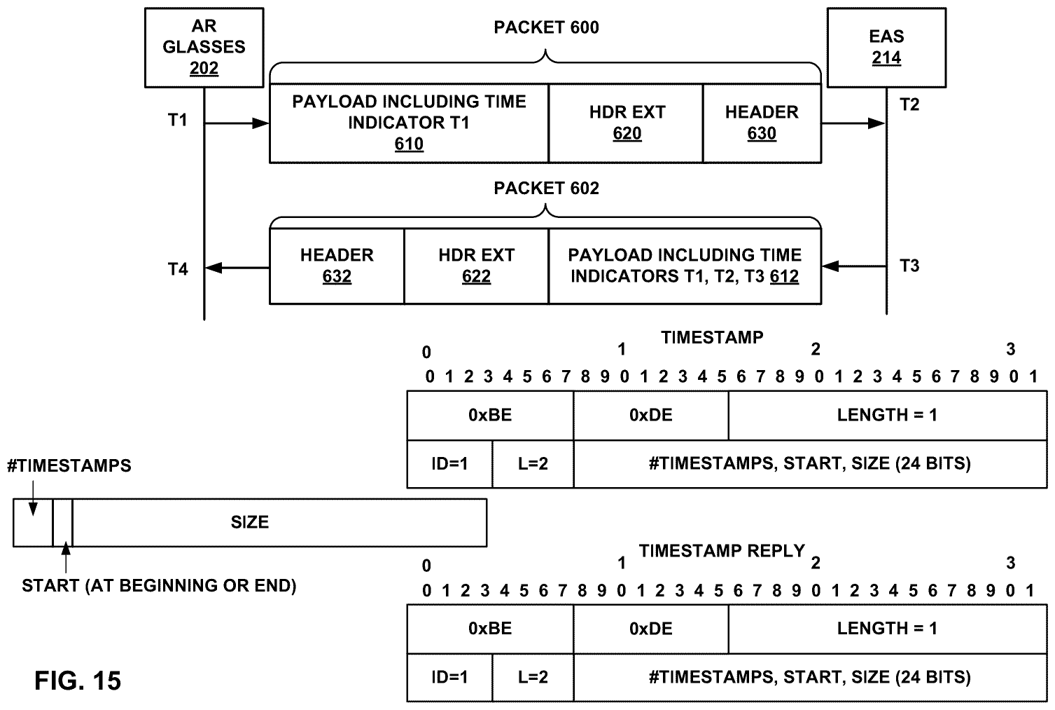

FIG. 15 is a conceptual diagram illustrating an example of the use of timestamps in a payload of an RTP packet according to one or more aspects of this disclosure. Packet 600 may be an RTP packet. Packet 600 may include: a payload 610, which may include first time indicator T1 and, for example, video data; a header extension 620, which may include one or more header extension elements, carrying information relating to first time indicator T1; and a header 630, which may be an RTP header.

Packet 602 may also be an RTP packet. Packet 602 may include: a payload 612, which in this example may include first time indicator T1, a second time indicator T2, a third time indicator T3, and video data; a header extension 622, which may include one or more header extension elements, carrying information relating to first time indicator T1, second time indicator T2, and third time indicator T3; and a header 632, which may be an RTP header. Edge application server 214 may determine second time indicator T2 upon receiving packet 600 and may determine third time indicator T3 after processing packet 600 and before transmitting packet 602. In some examples, a difference between second time indicator T2 and third time indicator T3 may represent a processing delay associated with edge application server 214 processing packet 600.

AR glasses 202 may determine a fourth time indicator T4 upon receiving packet 602. AR glasses 202 may use first time indicator T1, second time indicator T2, third time indicator T3, and/or time indicator T4 when determining a data packet delay.

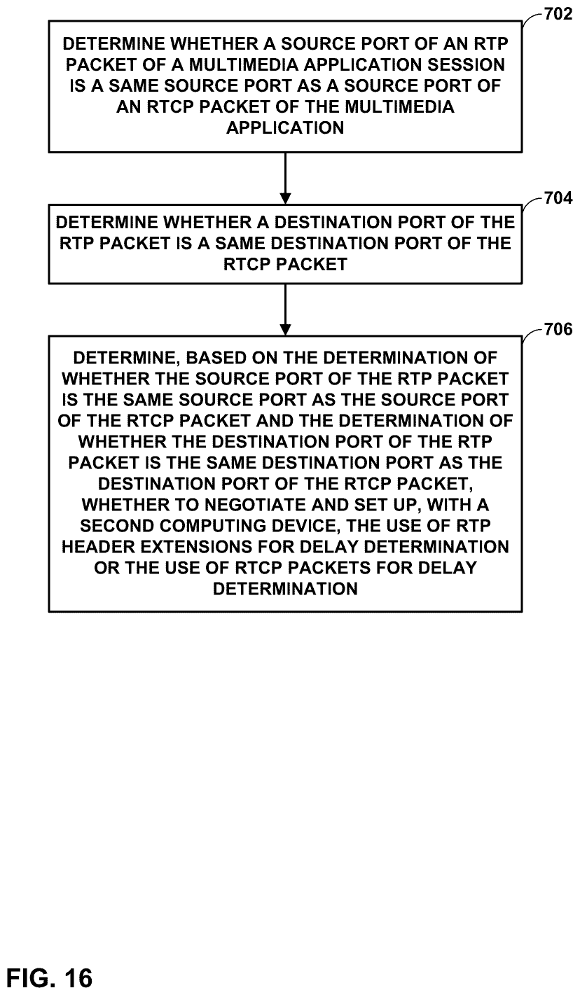

FIG. 16 is a flow diagram illustrating example delay measurement techniques according to one or more aspects of this disclosure. While the techniques of FIG. 16 are described with respect to AR glasses 302, the techniques of FIG. 16 may be practiced by any device capable of doing so, such as any of the computing devices described herein.

AR glasses 302 may determine whether a source port of an RTP packet of a multimedia application session is a same source port as a source port of an RTCP packet of the multimedia application session (702). For example, AR glasses 302 may examine a 5-tuple of an RTP packet of RTP packets 120 and a 5-tuple of an RTCP packet of RTCP packets 122 to determine whether the source port of the RTP packet and the RTCP packet is the same.

AR glasses 302 may determine whether a destination port of the RTP packet is a same destination port as a destination port of the RTCP (704). For example, AR glasses 302 may examine a 5-tuple of an RTP packet of RTP packets 120 and a 5-tuple of an RTCP packet of RTCP packets 122 to determine whether the destination port of the RTP packet and the RTCP packet is the same.

AR glasses 302 may determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination (706). For example, AR glasses 302 may determine to negotiate and set up the use of RTCP packets if both the source ports of the RTP packet and the RTCP packet are the same and the destination ports of the RTP packet and the RTCP packet are the same. For example, AR glasses 302 may determine to negotiate and set up the use of RTP header extensions if either, or both, the source ports of the RTP packet and the RTCP packet are different or the destination ports of the RTP packet and the RTCP packet are different. For example, AR glasses 302 may negotiate and set up the use of RTCP packets or RTP header extensions with application server 314.

In some examples, AR glasses 302 may determine that the source port of the RTP packet is the same source port as a source port of the RTCP packet and determine that the destination port of the RTP packet is the same destination port as the destination port of the RTCP packet. In some examples, AR glasses 302 may, based on the determination that the source port of the RTP packet is the same source port as a source port of the RTCP packet and the determination that the destination port of the RTP packet is the same destination port as the destination port of the RTCP packet, determine to negotiate and set up the use of RTCP packets for delay determination.

In some examples, negotiating and setting up the use of RTCP packets for delay determination includes determining a combination of types of RTCP messages to be sent. For example, AR glasses 302 may determine a combination of types of RTCP messages to be sent between AR glasses 302 and application server 314. In some examples, the combination of types of RTCP messages to be sent includes a sender report to be sent from one of the first computing device or the second computing device to another of the first computing device or the second computing device and a receiver report to be sent by the other of the first computing device or the second computing device to the one of the first computing device or the second computing device. In some examples, the combination of types of RTCP messages to be sent comprises a first sender report to be sent from one of the first computing device or the second computing device to another of the first computing device or the second computing device and a second sender report to be sent by the other of the first computing device or the second computing device to the one of the first computing device or the second computing device.

In some examples, the negotiating and setting up the use of RTCP packets for delay determination includes determining to use an RTCP message comprising a sender report comprising an originate timestamp, a receive timestamp, a transmit timestamp and an SSRC. For example, AR glasses 302 may determine to use an RTCP message comprising a sender report comprising an originate timestamp, a receive timestamp, a transmit timestamp and an SSRC.

In some examples, the negotiating and setting up the use of RTCP packets for delay determination includes determining a periodicity of the RTCP packets to be sent. For example, AR glasses 302 may determine a periodicity with which to send the RTCP messages.

In some examples, the RTCP packets include an RTCP timestamp message, wherein the RTCP timestamp message does not include a packet count, an octet count, a fraction lost, a cumulative number of packets lost, an extended highest sequence number received, and an interarrival jitter. For example, the RTCP packets may include an RTCP timestamp message similar to RTCP timestamp message 380 of FIG. 8.

In some examples, AR glasses 302 may determine at least one of a) that the source port of the RTP packet is not the same source port as a source port of the RTCP packet or b) that the destination port of the RTP packet is not the same destination port as the destination port of the RTCP packet. In some examples, AR glasses 302 may, based on the determination that at least one of the source port of the RTP packet is not the same source port as a source port of the RTCP packet or the destination port of the RTP packet is not the same destination port as the destination port of the RTCP packet, determine to negotiate and set up the use of RTP header extensions for delay determination.

In some examples, at least one of the first computing device or the second computing device may determine a delay based on the use of the RTP header extensions or the use of the RTCP packets. For example, AR glasses 302 or application server 314 may determine the delay. In some examples, the delay includes a round trip time (RTT), a one-way uplink delay, or a one-way downlink delay.

In some examples, the multimedia application session includes a plurality of flows each associated with corresponding type of data. In some examples, AR glasses 302 may determine, for each respective flow of the plurality of flows, whether a corresponding source port of an RTP packet of the respective flow is a same corresponding source port as a corresponding source port of an RTCP packet of the multimedia application session. AR glasses 302 may determine, by the first computing device and for each respective flow of the plurality of flows, whether a corresponding destination port of the RTP packet of the respective flow is a same corresponding destination port as a corresponding destination port of the RTCP packet of the multimedia application session.

Various examples of the techniques of this disclosure are summarized in the following clauses:

Clause 1A: A method comprising: determining, by a first computing device, whether Real-Time Transport Protocol (RTP) and Real-Time Transport Control Protocol (RTCP) packets of a first multimedia application session are multiplexed into a first plurality of same ports; and based on a determination that the RTP and RTCP packets of the first multimedia application session are not multiplexed into the first plurality of same ports, negotiating and setting up, by the first computing device with a second computing device, the use of an RTP header extension for delay determination.

Clause 2A. The method of clause 1A, further comprising: determining, by at least one of the first computing device or the second computing device, a delay based on the use of the RTP header extension.

Clause 3A. The method of clause 2A, wherein the delay comprises an RTT, a one-way uplink delay, or a one-way downlink delay.

Clause 4A. The method of any of clauses 1A-3A, further comprising: determining, by the first computing device, whether RTP and RTCP packets of a second multimedia application session are multiplexed into a second plurality of same ports; and based on a determination that the RTP and RTCP packets of the second multimedia application session are multiplexed into the second plurality of same ports, negotiating and setting up, by the first computing device with a third computing device, the use of RTCP for delay determination.

Clause 5A. The method of any of clauses 1A-4A, wherein the determination that RTP and RTCP packets of a first multimedia application session are multiplexed into a first plurality of same ports comprises a determination that all media of the RTP packets is mapped to a same pair of ports as the RTCP packets or that the media of the RTP packets is mapped to a same plurality of pairs of ports as the RTCP packets.

Clause 6A. The method of clause 4A or clause 5A, wherein the negotiating and setting up the use of RTCP for delay determination comprises determining a combination of types of RTCP messages to be sent.

Clause 7A. The method of clause 6A, wherein the combination of types of RTCP messages to be sent comprises a sender report to be sent from one of the first computing device or the third computing device to another of the first computing device or the third computing device and a receiver report to be sent by the other of the first computing device or the third computing device to the one of the first computing device or the third computing device.

Clause 8A. The method of clause 6A, wherein the combination of types of RTCP messages to be sent comprises a first sender report to be sent from one of the first computing device or the third computing device to another of the first computing device or the third computing device and a second sender report to be sent by the other of the first computing device or the third computing device to the one of the first computing device or the second computing device.

Clause 9A. The method of any of clauses 4A-5A, wherein the negotiating and setting up the use of RTCP for delay determination comprises determining to use an RTCP message comprising a sender report comprising an originate timestamp, a receive timestamp, a transmit timestamp and a synchronization source (SSRC).

Clause 10A. The method of any of clauses 4A-9A, wherein the negotiating and setting up the use of RTCP for delay determination comprises determining a periodicity of the RTCP messages to be sent.

Clause 11A. A computing device, comprising: memory configured to store port data; and one or more processors coupled to the memory, the one or more processors being configured to perform any of the methods of clauses 1A-10A.

Clause 12A. The computing device of clause 11A, wherein the computing device comprises a mobile device or an application server.

Clause 13A. A computing device comprising at least one means for performing any of the methods of clauses 1A-10A.

Clause 14A. Computer-readable storage media storing instructions, which, when executed, cause one or more processors to perform any of the methods of clauses 1A-10A.

Clause 1B. A method comprising: determining, by a first computing device, whether a source port of a Real-Time Transport Protocol (RTP) packet of a multimedia application session is a same source port as a source port of a Real-Time Transport Control Protocol (RTCP) packet of the multimedia application session; determining, by the first computing device, whether a destination port of the RTP packet is a same destination port as a destination port of the RTCP packet; and determining, by the first computing device and based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

Clause 2B. The method of claim 1B, determining that the source port of the RTP packet is the same source port as a source port of the RTCP packet; determining that the destination port of the RTP packet is the same destination port as the destination port of the RTCP packet; and based on the determination that the source port of the RTP packet is the same source port as a source port of the RTCP packet and the determination that the destination port of the RTP packet is the same destination port as the destination port of the RTCP packet, determining to negotiate and set up the use of RTCP packets for delay determination.

Clause 3B. The method of claim 2B, wherein the negotiating and setting up the use of RTCP packets for delay determination comprises determining a combination of types of RTCP messages to be sent.

Clause 4B. The method of claim 3B, wherein the combination of types of RTCP messages to be sent comprises a sender report to be sent from one of the first computing device or the second computing device to another of the first computing device or the second computing device and a receiver report to be sent by the other of the first computing device or the second computing device to the one of the first computing device or the second computing device.

Clause 5B. The method of claim 3B, wherein the combination of types of RTCP messages to be sent comprises a first sender report to be sent from one of the first computing device or the second computing device to another of the first computing device or the second computing device and a second sender report to be sent by the other of the first computing device or the second computing device to the one of the first computing device or the second computing device.

Clause 6B. The method of any of claims 2B-5B, wherein the negotiating and setting up the use of RTCP packets for delay determination comprises determining to use an RTCP message comprising a sender report comprising an originate timestamp, a receive timestamp, a transmit timestamp and a synchronization source (SSRC).

Clause 7B. The method of any of claims 2B-6B, wherein the negotiating and setting up the use of RTCP packets for delay determination comprises determining a periodicity of the RTCP packets to be sent.

Clause 8B. The method of claim 2B or 7B, wherein the RTCP packets comprise an RTCP timestamp message, wherein the RTCP timestamp message does not include a packet count, an octet count, a fraction lost, a cumulative number of packets lost, an extended highest sequence number received, and an interarrival jitter.

Clause 9B. The method of claim 1B, determining at least one of a) that the source port of the RTP packet is not the same source port as a source port of the RTCP packet or b) that the destination port of the RTP packet is not the same destination port as the destination port of the RTCP packet; and based on the determination that at least one of the source port of the RTP packet is not the same source port as a source port of the RTCP packet or the destination port of the RTP packet is not the same destination port as the destination port of the RTCP packet, determining to negotiate and set up the use of RTP header extensions for delay determination.

Clause 10B. The method of any of claims 1B-9B, further comprising: determining, by at least one of the first computing device or the second computing device, a delay based on the use of the RTP header extensions or the use of the RTCP packets.

Clause 11B. The method of claim 10B, wherein the delay comprises a round trip time (RTT), a one-way uplink delay, or a one-way downlink delay.

Clause 12B. The method of any of claims 1B-11B, wherein the multimedia application session comprises a plurality of flows each associated with corresponding type of data, and wherein the method further comprises: determining, by the first computing device and for each respective flow of the plurality of flows, whether a corresponding source port of an RTP packet of the respective flow is a same corresponding source port as a corresponding source port of an RTCP packet of the multimedia application session; and determining, by the first computing device and for each respective flow of the plurality of flows, whether a corresponding destination port of the RTP packet of the respective flow is a same corresponding destination port as a corresponding destination port of the RTCP packet of the multimedia application session.

Clause 13B. A computing device, comprising: one or more memories configured to store a first data packet; and one or more processors in communication with the one or more memories, the one or more processors being configured to: determine whether a source port of a Real-Time Transport Protocol (RTP) packet of a multimedia application session is a same source port as a source port of a Real-Time Transport Control Protocol (RTCP) packet of the multimedia application session; determine whether a destination port of the RTP packet is a same destination port as a destination port of the RTCP packet; and determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

Clause 14B. The device of claim 13B, determine that the source port of the RTP packet is the same source port as a source port of the RTCP packet; determine that the destination port of the RTP packet is the same destination port as the destination port of the RTCP packet; and based on the determination that the source port of the RTP packet is the same source port as a source port of the RTCP packet and the determination that the destination port of the RTP packet is the same destination port as the destination port of the RTCP packet, determine to negotiate and set up the use of RTCP packets for delay determination.

Clause 15B. The device of claim 14B, wherein as part of negotiating and setting up the use of RTCP packets for delay determination, the one or more processors are configured to determine a combination of types of RTCP messages to be sent.

Clause 16B. The device of claim 15B, wherein the combination of types of RTCP messages to be sent comprises a sender report to be sent from one of the first computing device or the second computing device to another of the first computing device or the second computing device and a receiver report to be sent by the other of the first computing device or the second computing device to the one of the first computing device or the second computing device.

Clause 17B. The device of claim 15B, wherein the combination of types of RTCP messages to be sent comprises a first sender report to be sent from one of the first computing device or the second computing device to another of the first computing device or the second computing device and a second sender report to be sent by the other of the first computing device or the second computing device to the one of the first computing device or the second computing device.

Clause 18B. The device of claim 14B, wherein the RTCP packets comprise an RTCP timestamp message, wherein the RTCP timestamp message does not include a packet count, an octet count, a fraction lost, a cumulative number of packets lost, an extended highest sequence number received, and an interarrival jitter.

Clause 19B. The device of claim 13B, determine at least one of a) that the source port of the RTP packet is not the same source port as a source port of the RTCP packet or b) that the destination port of the RTP packet is not the same destination port as the destination port of the RTCP packet; and based on the determination that at least one of the source port of the RTP packet is not the same source port as a source port of the RTCP packet or the destination port of the RTP packet is not the same destination port as the destination port of the RTCP packet, determine to negotiate and set up the use of RTP header extensions for delay determination.

Clause 20B. Computer-readable storage media storing instructions, which, when executed, cause one or more processors to: determine whether a source port of a Real-Time Transport Protocol (RTP) packet of a multimedia application session is a same source port as a source port of a Real-Time Transport Control Protocol (RTCP) packet of the multimedia application session; determine whether a destination port of the RTP packet is a same destination port as a destination port of the RTCP packet; and determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

In one or more examples, the functions described may be implemented in hardware, software, firmware, or any combination thereof. If implemented in software, the functions may be stored on or transmitted over as one or more instructions or code on one or more computer-readable media and executed by one or more hardware-based processing units. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include one or more computer-readable media.

By way of example, and not limitation, such computer-readable storage media can comprise RAM, ROM, EEPROM, CD-ROM and/or other optical disk storage, magnetic disk storage, and/or other magnetic storage devices, flash memory, and/or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, by a first computing device, whether a source port of a Real-Time Transport Protocol (RTP) packet of a multimedia application session is a same source port as a source port of a Real-Time Transport Control Protocol (RTCP) packet of the multimedia application session;
determining, by the first computing device, whether a destination port of the RTP packet is a same destination port as a destination port of the RTCP packet; and
determining, by the first computing device and based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

2. The method of claim 1, further comprising:
determining that the source port of the RTP packet is the same source port as a source port of the RTCP packet;
determining that the destination port of the RTP packet is the same destination port as the destination port of the RTCP packet; and
based on the determination that the source port of the RTP packet is the same source port as a source port of the RTCP packet and the determination that the destination port of the RTP packet is the same destination port as the destination port of the RTCP packet, determining to negotiate and set up the use of RTCP packets for delay determination.

3. The method of claim 2, wherein the negotiating and setting up the use of RTCP packets for delay determination comprises determining a combination of types of RTCP messages to be sent.

4. The method of claim 3, wherein the combination of types of RTCP messages to be sent comprises a sender report to be sent from one of the first computing device or the second computing device to another of the first computing device or the second computing device and a receiver report to be sent by the other of the first computing device or the second computing device to the one of the first computing device or the second computing device.

5. The method of claim 3, wherein the combination of types of RTCP messages to be sent comprises a first sender report to be sent from one of the first computing device or the second computing device to another of the first computing device or the second computing device and a second sender report to be sent by the other of the first computing device or the second computing device to the one of the first computing device or the second computing device.

6. The method of claim 2, wherein the negotiating and setting up the use of RTCP packets for delay determination comprises determining to use an RTCP message comprising a sender report comprising an originate timestamp, a receive timestamp, a transmit timestamp and a synchronization source (SSRC).

7. The method of claim 2, wherein the negotiating and setting up the use of RTCP packets for delay determination comprises determining a periodicity of the RTCP packets to be sent.

8. The method of claim 2, wherein the RTCP packets comprise an RTCP timestamp message, wherein the RTCP timestamp message does not include a packet count, an octet count, a fraction lost, a cumulative number of packets lost, an extended highest sequence number received, and an interarrival jitter.

9. The method of claim 1, further comprising:
determining at least one of a) that the source port of the RTP packet is not the same source port as a source port of the RTCP packet or b) that the destination port of the RTP packet is not the same destination port as the destination port of the RTCP packet; and
based on the determination that at least one of the source port of the RTP packet is not the same source port as a source port of the RTCP packet or the destination port of the RTP packet is not the same destination port as the destination port of the RTCP packet, determining to negotiate and set up the use of RTP header extensions for delay determination.

10. The method of claim 1, further comprising:
determining, by at least one of the first computing device or the second computing device, a delay based on the use of the RTP header extensions or the use of the RTCP packets.

11. The method of claim 10, wherein the delay comprises a round trip time (RTT), a one-way uplink delay, or a one-way downlink delay.

12. The method of claim 1, wherein the multimedia application session comprises a plurality of flows each associated with corresponding type of data, and wherein the method further comprises:
determining, by the first computing device and for each respective flow of the plurality of flows, whether a corresponding source port of an RTP packet of the respective flow is a same corresponding source port as a corresponding source port of an RTCP packet of the multimedia application session; and
determining, by the first computing device and for each respective flow of the plurality of flows, whether a corresponding destination port of the RTP packet of the respective flow is a same corresponding destination port as a corresponding destination port of the RTCP packet of the multimedia application session.

13. A computing device, comprising:
one or more memories configured to store a first data packet; and
one or more processors in communication with the one or more memories, the one or more processors being configured to:
determine whether a source port of a Real-Time Transport Protocol (RTP) packet of a multimedia application session is a same source port as a source port of a Real-Time Transport Control Protocol (RTCP) packet of the multimedia application session;
determine whether a destination port of the RTP packet is a same destination port as a destination port of the RTCP packet; and
determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.

14. The device of claim 13, wherein the processing circuitry is further configured to:
determine that the source port of the RTP packet is the same source port as a source port of the RTCP packet;
determine that the destination port of the RTP packet is the same destination port as the destination port of the RTCP packet; and
based on the determination that the source port of the RTP packet is the same source port as a source port of the RTCP packet and the determination that the destination port of the RTP packet is the same destination port as the destination port of the RTCP packet, determine to negotiate and set up the use of RTCP packets for delay determination.

15. The device of claim 14, wherein as part of negotiating and setting up the use of RTCP packets for delay determination, the one or more processors are configured to determine a combination of types of RTCP messages to be sent.

16. The device of claim 15, wherein the combination of types of RTCP messages to be sent comprises a sender report to be sent from one of the first computing device or the second computing device to another of the first computing device or the second computing device and a receiver report to be sent by the other of the first computing device or the second computing device to the one of the first computing device or the second computing device.

17. The device of claim 15, wherein the combination of types of RTCP messages to be sent comprises a first sender report to be sent from one of the first computing device or the second computing device to another of the first computing device or the second computing device and a second sender report to be sent by the other of the first computing device or the second computing device to the one of the first computing device or the second computing device.

18. The device of claim 14, wherein the RTCP packets comprise an RTCP timestamp message, wherein the RTCP timestamp message does not include a packet count, an octet count, a fraction lost, a cumulative number of packets lost, an extended highest sequence number received, and an interarrival jitter.

19. The device of claim 13, wherein the processing circuitry is further configured to:
determine at least one of a) that the source port of the RTP packet is not the same source port as a source port of the RTCP packet or b) that the destination port of the RTP packet is not the same destination port as the destination port of the RTCP packet; and
based on the determination that at least one of the source port of the RTP packet is not the same source port as a source port of the RTCP packet or the destination port of the RTP packet is not the same destination port as the destination port of the RTCP packet, determine to negotiate and set up the use of RTP header extensions for delay determination.

20. Computer-readable storage media storing instructions, which, when executed, cause one or more processors to:
determine whether a source port of a Real-Time Transport Protocol (RTP) packet of a multimedia application session is a same source port as a source port of a Real-Time Transport Control Protocol (RTCP) packet of the multimedia application session;
determine whether a destination port of the RTP packet is a same destination port as a destination port of the RTCP packet; and
determine, based on the determination of whether the source port of the RTP packet is the same source port as the source port of the RTCP packet and the determination of whether the destination port of the RTP packet is the same destination port as the destination port of the RTCP packet, whether to negotiate and set up, with a second computing device, the use of RTP header extensions for delay determination or the use of RTCP packets for delay determination.
